(19) United States
(12) Patent Application Publication
(10) Pub. No.: US 2018/0332406 A1
(43) Pub. Date: Nov. 15, 2018

(54) ACOUSTIC OUTPUT DEVICE

(71) Applicant: MODA-INNOCHIPS CO., LTD., Ansan-Si, Gyeonggi-Do (KR)

(72) Inventors: Sung Chol PARK, Ansan-Si, Gyeonggi-Do (KR); In Seob JEONG, Ansan-Si, Gyeonggi-Do, (KR); Sang Hun PARK, Seoul (KR)

(21) Appl. No.: 15/775,820

(22) PCT Filed: Oct. 28, 2016
(86) PCT No.: PCT/KR2016/012304

§ 371 Date: May 11, 2018

(30) Foreign Application Priority Data
Nov. 13, 2015 (KR) 10-2015-0159958

(51) Int. Cl. H04R 23/02; H04R 1/10; H04R 7/02; H04R 9/06; H04R 17/00

(52) U.S. Cl. CPC H04R 23/02; H04R 1/1016; H04R 17/00; H04R 7/02; H04R 9/06; H04R 1/1075

(57) ABSTRACT

Provided is a sound output apparatus. The sound output apparatus includes a first sound output part and a second sound output part disposed to contact at least a portion of the first sound output part, and a case configured to accommodate the first and second output parts.

### BACKGROUND

The present disclosure relates to a sound output apparatus, and more particularly, to a sound output apparatus capable of improving output characteristics of an audible frequency band including a low pitch sound band and a high pitch sound band.

Generally, piezoelectric devices represent devices having characteristics of converting mechanical energy and electrical energy to each other. That is, in the piezoelectric devices, a voltage is generated when a pressure is applied (piezoelectric effect), a volume or a length increases or decreases due to a change of an internal pressure when a voltage is applied (reverse piezoelectric effect). The piezoelectric devices are constituted by a piezoelectric layer and an electrode disposed on a top surface thereof to change a pressure according to a voltage applied to the piezoelectric layer through the electrode.

Various components such as a piezoelectric speaker and a vibrating device may be manufactured by using the above-described piezoelectric devices. In the various components described above, the piezoelectric speaker is a component that generates a sound having a desired frequency band by acoustically converting a mechanical movement of a piezoelectric plate through a diaphragm. The piezoelectric speaker is thin in thickness, light in weight, and low in power consumption when compared to a dynamic speaker in the related art. Therefore, the piezoelectric speaker may be used in electronic devices such as smart-phones that are miniaturized, thin, and lightweight. However, in the piezoelectric speaker, since the high pitch sound is strong and the low pitch sound is weak, it is hard to listen for a long time.

Generally, the dynamic speaker is widely used for playing music. The dynamic speaker uses a principal in which the mechanical force is applied to a voice coil to generate a movement according to the intensity of current when the voice signal current flows through the voice coil provided in a magnetic field of a magnet. The dynamic speaker is suitable for realizing the low pitch sound but relatively unsuitable for realizing the high pitch sound. Therefore, the dynamic speaker may not provide a high quality sound.

### PRIOR ART DOCUMENTS

Korean Patent Publication No. 2014-0083860

Korean Patent Registration No. 10-1212705

### SUMMARY

The present disclosure provides a sound output apparatus having all advantages of a piezoelectric speaker and a dynamic speaker.

The present disclosure provides a sound output apparatus to improve low pitch sound characteristics and high pitch sound characteristics together.

In accordance with an exemplary embodiment, a sound output apparatus includes: a first sound output part; a second sound output part disposed to contact at least a portion of the first sound output part; and a case configured to accommodate the first and second sound output parts.

The first sound output part may include a voice coil and a vibrating member, and the second sound output part comprises a piezoelectric plate.

An opening may be defined in one area of the vibrating member, and a diaphragm and the piezoelectric plate may be provided on the opening.

The piezoelectric plate may be disposed on one area of the vibrating member.

The case may include lower and upper cases, and an edge of the vibrating member may be held between the lower and upper cases.

The second sound output part may be disposed at a side of the upper case.

The sound output apparatus further includes the a hole defined in the upper case to emit sounds generated from the first and second sound output parts.

The case may be provided with a size that is enough to be inserted into an ear of a user and inserted into the ear from the second sound output part.

### BRIEF DESCRIPTION OF THE DRAWINGS

Exemplary embodiments can be understood in more detail from the following description taken in conjunction with the accompanying drawings, in which:

FIG. 1 is an exploded perspective view of a sound output apparatus in accordance with an exemplary embodiment;

FIG. 2 is the combined cross-sectional view of a sound output apparatus in accordance with an exemplary embodiment;

FIG. 3 is an exploded perspective view of a sound output apparatus in accordance with another exemplary embodiment; and

FIG. 4 is the combined cross-sectional view of a sound output apparatus in accordance with another exemplary embodiment.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

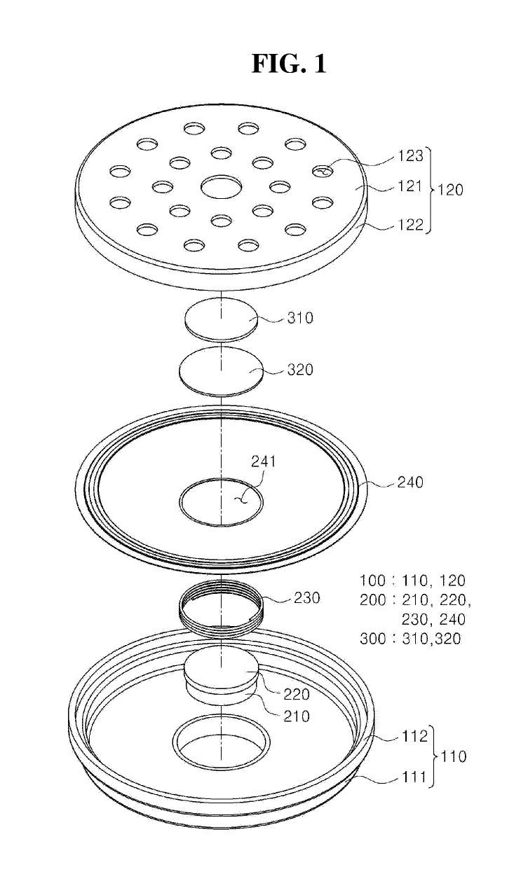

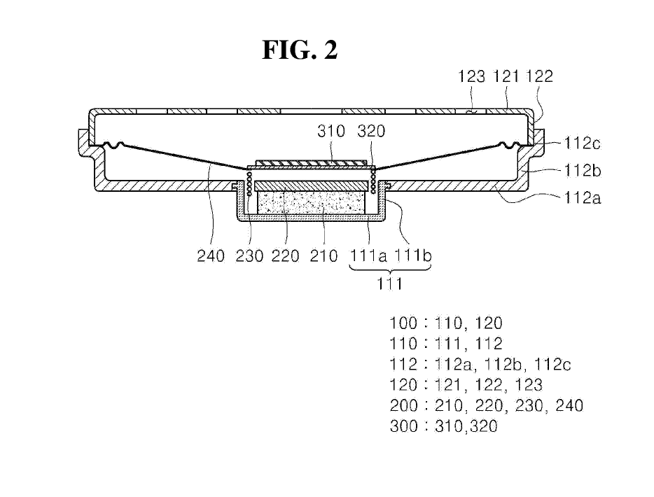

FIG. 1 is an exploded perspective view of a sound output apparatus in accordance with an exemplary embodiment, and FIG. 2 is a combined cross-sectional view of a sound output apparatus.

Referring to FIGS. 1 to 2, a sound output apparatus in accordance with an exemplary embodiment may include a case 100 in which a predetermined space is provided, a first sound output part 200 provided within the case 100, and a second sound output part 300 provided within the case 100 and contacted to at least a portion of the first sound output part 200. Here, the first sound output part 200 may include a voice coil 230 and a vibrating member 240 to vibrate according to a change of current in the voice coil 230. In addition, the first output part 200 may include a dynamic speaker that vibrates the vibrating member 240 to output a sound by using the above-described vibration. Also, the second sound output part 300 includes a piezoelectric plate 310 and a diaphragm 320. That is, the second sound output 300 may include a piezoelectric speaker that acoustically converts a mechanical movement of the piezoelectric plate 310 by the diaphragm 320.

The case 100 has a predetermined space therein and accommodates the first and second output parts 200 and 300. The case 100 includes a lower case 110 and an upper case 120, and the lower case 110 is coupled to the upper case 120 to define the predetermined space therein. The lower case 110 may include a first region 111 having an approximately circular shape and a predetermined height and a second region 112 that is defined above the first region 111 in an approximately circular shape and has a predetermined height. However, the first and second regions 111 and 112 may be provided in a polygonal shape such as a square shape and the like in addition to the circular shape. Here, the second region 112 may have the height greater than that of the first region 111. Also, the second region 112 may have a width greater than that of the first region 111. Alternatively, the second region 112 may have the height less than or equal to that of the first region 111. The first region 111 may include a first horizontal portion 111a having an approximately circular shape and a first vertical portion 111b formed at a predetermined height upward from an edge of the first horizontal portion 111a to define a predetermined space therein. The second region 112 may include a second horizontal portion 112a having a predetermined width in a horizontal direction from an upper edge of the first vertical portion 111b and a second vertical portion 112b having a predetermined height upward from an edge of the second horizontal portion 112a to provide a predetermined space therein. Thus, the second region 112 may has an inner space greater than that of the first region 111. Also, the second region 112 may further include an extension portion 112c that is formed by extending by a predetermine width outward from an upper edge of the second vertical portion 112b and then being defined upward therefrom.

The upper case 120 may have a recessed region facing the inner space of the lower case 110. That is, the upper case 120 may include a third horizontal portion 121 having an approximately circular plate shape, a third vertical portion 122 extending in a downward direction from an edge of the third horizontal portion 121, i.e., in a direction of the lower case 110. Here, the third vertical portion 122 of the upper case 120 is inserted into the extension portion 112c of the second region 112, and thus the upper case 120 may be coupled to the lower case 110. Also, a plurality of holes 123 are defined in the third horizontal portion 121 of the upper case 120. The hole 123 are provided to emit a sound generated in the first and second sound output parts 200 and 300 from the inside of the case 100 to the outside. The hole 123 may be defined in plurality with the same diameter and at the same distance. Alternatively, at least one hole may be defined with a diameter and distance different from those of the other hole. For example, one hole 123 defined in a central portion of the upper case 120 has a first diameter. On the other hand, each of a plurality of holes 123 defined around the one hole may have a second diameter less than the first diameter. Also, the plurality of holes 123 may have diameters that gradually decrease outward from the central portion. The holes 123 may be defined to have the total area corresponding to 5% to 90% of an area of a top surface of the first sound output part 200, i.e., an area of the vibrating member 240. Alternatively, the holes 123 may be defined to have the total area corresponding to 10% to 60% of an area of the top surface of the first sound output part 200. Also, the holes 123 may be defined to have the total area corresponding to 15% to 30% of an area of the top surface of the first sound output part 200.

The first sound output part 200 may include a magnet 210, a plate 220 provided on the magnet 210, the voice coil 230 provided to surround the plate 220 and at least a portion of the magnet 210, and the vibrating member 240 that is provided above the plate 220 and has an edge fixed to the case 110 and to which the voice coil 230 is fixed. Here, the magnet 210 and the plate 220 may be accommodated inside of the first region 111 of the lower case 110, and the voice coil 230 may be accommodated inside the second region 112 of the lower case 110. Also, the vibrating member 240 may be provided above the second region 112 to cover the second region 112 of the lower case 110. Here, the lower case 110 induces magnetic fields generated by the magnet 210 to the plate 220 so that the voice coil 230 is maximally affected by magnetic force due to the magnet 210.

The magnet 210 is fixed to a bottom of the inside of the first region 111 of the lower case 110. That is, the magnet 210 is fixed to a top surface of the first horizontal portion 111a. The magnet 210 may has a shape corresponding to an inner shape of the first region 111 of the lower case 110. For example, when the inside of the first region 111a is provided in an approximately cylindrical shape, the magnet 210 may have an approximately cylindrical shape. Here, the magnet 210 may have a height less than or equal to that of the first region 111. Also, the magnet 210 may have a diameter less than that of the first region 111. Therefore, the magnet 210 may be spaced a predetermined distance from an inner wall of the first region 111 in the first region 111 of the lower case 110.

The plate 220 may be disposed on the magnet 210. Here, the plate 220 may have the same shape as a plane of the magnet 210. That is, the plate 220 may be provided in a circular plate shape with a predetermined thickness. Here, the plate 220 may have a diameter less than the inner diameter of the first region 111 of the lower case 110 and greater than or equal to that of the magnet 210. Therefore, the plate 220 may have an outer surface spaced a predetermined distance from the inner surface of the first region 111. Also, the total height of the magnet 210 and the plate 220 provided on the magnet 210 may be equal to the height of the first region 111. That is, the plate 220 and the top surface of the first region 111 may be flush with each other. The plate 220 allows lines of magnetic force generated by the magnet 210 to be collected to the voice coil 230.

The voice coil 230 may be disposed between the first region 111 of the lower case 110 and the magnet 210 from a bottom surface of the vibrating member 240. For example, the voice coil 230 has one end contacting the bottom surface of the vibrating member 240 and the other end extending to the inside of the first region 111. That is, the voice coil 230 may be disposed between the plate and magnet 220 and 210 and the first region 111 to surround the plate 220 and a portion of the magnet 210 disposed under the plate 220. Also, the upper portion of the voice coil 230 contacts the bottom surface of the vibrating member 240. The voice coil 230 generates a magnetic filed that is continuously changed by an electrical signal inputted while being continuously changed, and thus the voice coil 230 vibrates by the interaction due to the interference with magnetic fields generated by the magnet 210.

The vibrating member 240 has an edge fixed between the lower and upper cases 110 and 120 and is provided to cover the lower case 120. Here, an opening 241 is defined to open a central area of the vibrating member 240, and the vibrating member 240 extends upward at a predetermined angle from the opening 241 so that the edge of the vibrating member 240 is held between the lower and upper cases 110 and 120. For example, the vibrating member 240 may have an opened region facing the plate 220 and extend from an edge of the opened region to the extension portion 112c of the second region 112 of the lower case 110. Also, the second sound output part 300 may be provided on the opening 241 of the vibrating member 240. The vibrating member 240 may be formed of a polymer-based or pulp-based material.

The first sound output part 200 constitutes a closed circuit in which the magnetic field generated from the magnet 210 moves to the first region 111 of the lower case 110, which is disposed under the first sound output part 200, through the plate 220 provided on the magnet 210 and then moves again to the magnet 210. The magnetic field moving to a space between the plate 220 and the first region 111 defined under the plate 220 pulls or pushes the voice coil 230 according to a magnetic polarity of the voice coil 230 when current is applied to the voice coil 230 to magnetize the voice coil 230. That is, when the magnetic polarity of the voice coil 230 is the same as that of the first region 111 defined under the plate 220, the voice coil 230 is pushed out by repulsion therebetween to move the voice coil 230 forward. Alternatively, when the magnetic polarity of the plate 220 is different from that of the first region 111 defined under the plate 200, the voice coil 230 is pulled backward by attraction therebetween. When the voice coil 230 moves as described above, the vibrating member 240 to which the voice coil 230 is fixed moves forward and backward to vibrate air, thereby generating a sound.

The second sound output part 300 may include the piezoelectric plate 310 and the diaphragm 320. Here, the diaphragm 320 has an edge contacting the vibrating member 240 and is disposed on the opening 241, and the piezoelectric plate 310 is disposed on a top surface of the diaphragm 320. Thus, the diaphragm 320 is spaced a predetermined distance from the plate 220 to face the plate 220. The piezoelectric plate 310 may have, for example, a circular plate shape having a predetermined thickness. Alternatively, the piezoelectric plate 310 may have various shapes such as a square shape, a rectangular shape, an oval shape, and a polygonal shape in addition to the circular shape. The piezoelectric plate 310 may include a substrate and a piezoelectric layer disposed on at least a surface of the substrate. For example, the piezoelectric plate 310 may be provided as a bimorph type piezoelectric device in which the piezoelectric layers are disposed on both surfaces of the substrate or a unimorph type piezoelectric device in which the piezoelectric layer is disposed on one surface of the substrate. At least one layer may be laminated to form the piezoelectric layer. For example, a plurality of layers may be laminated on each other to form the piezoelectric layer. Also, an electrode may be formed on each of top and bottom surfaces of the piezoelectric layer. That is, the plurality of piezoelectric layers and the plurality of electrodes are alternately laminated on each other to realize the piezoelectric plate 310. Here, the piezoelectric layer may be formed of, for example, a PZT (Pb, Zr, Ti), NKN (Na, K, Nb), BNT (Bi, Na, Ti), or polymer-based piezoelectric material. Also, the piezoelectric layers may be polarized in directions different from each other or in the same direction and then be laminated on each other. That is, when the plurality of piezoelectric layers are formed on one surface of the substrate, the polarizations of the piezoelectric layers may be alternately formed in directions opposite to each other or in the same direction. Also, the substrate may be formed of a material having a property in which vibration is generated while maintaining the structure in which the piezoelectric layers are laminated, for example, a metal or plastic. However, the piezoelectric plate 310 may not use the piezoelectric layer and the substrate. For example, a piezoelectric layer that is not polarized may be provided at a central portion of the piezoelectric plate 310, and a plurality of piezoelectric layers that are polarized in directions different from each other may be laminated above and under the above-described piezoelectric layer to form the piezoelectric plate 310. Also, an electrode pattern (not shown) to which a driving signal is applied is formed on an upper portion of a surface of the piezoelectric plate 310. At least two or more of the electrode patterns may be formed to be spaced apart from each other and connected to a connection terminal (not shown) so that a sound signal is inputted from an electronic device, for example, an auxiliary mobile device through the connection terminal.

The diaphragm 320 may be provided in an approximately circular plate shape in size greater than that of the piezoelectric plate 310. The piezoelectric plate 310 is bonded to a top surface of the vibrating plate 320 by adhesive. The vibrating plate 320 may be formed of a polymer-based or pulp-based material. For example, the diaphragm 320 may be formed of a resin film. That is, the diaphragm 320 may be formed of a material having a large loss coefficient with a Young's modulus of 1 MPa to 10 MPa such as an ethylene propylene rubber-based material and a styrene butadiene rubber-based material. Also, the diaphragm 320 may have a lower edge contacting the vibrating member 240. That is, the vibration plate 320 may be disposed on the opening of the vibrating member 240 to face the plate 220. The second sound output part 300 may be driven according to a predetermined signal to output a sound having superior characteristic in high pitch sound.

Also, the sound output apparatus in accordance with an exemplary embodiment may be manufactured in such a manner that the magnet 210 and the plate 220 are provided inside the first region 111 of the lower case 110, the vibrating member 240 under which the voice coil 230 is provided and above which the diaphragm 320 and the piezoelectric plate 310 are provided is disposed so that the voice coil 230 surrounds the plate 220 and the portion of the magnet 210 and an edge of the vibrating member 240 is seated on the extension portion 112c of the second region, and then the third vertical portion 122 is inserted into the extension portion 112c. Alternatively, the diaphragm 310 and the piezoelectric plate 330 may be adhered to the opening 241 of the vibrating plate 240 after seating the vibrating member 240 on the extension portion 112c in advance.

Also, the sound output apparatus in accordance with the exemplary embodiment may be manufactured into speakers such as a speaker for an automobile and a speaker for home use or earphones such as a canal-type earphone constituted by an amplifier, an eartip, and a hollow type nozzle. When the sound output apparatus is manufactured as the earphone, the case 100 may be manufactured with an approximate size capable of being inserted into an ear. Here, the case 100 may be inserted into the ears from the upper case 120.

As described above, the sound output apparatus in accordance with the exemplary embodiment includes the diaphragm 320 and the piezoelectric plate 310 of the second sound output part 300 on the opening of the vibrating member 240 of the first sound output part 200. Also, the same electric signal may be applied to the voice coil 230 of the first sound output part 200 and the piezoelectric plate 310 of the second sound output part 300. Since the electrical signal is applied to the piezoelectric plate 310, sound suitable for the low pitch sound band is generated in the vibrating member 240, and the sound suitable for the high pitch sound band is generated through the diaphragm 320. For example, the first sound output part 200 having superior characteristics in the low pitch sound having a frequency ranging up to approximately 7 kHz, i.e., the dynamic speaker and the second sound output part 300 having superior characteristics in the high pitch sound having a frequency of 8 kHz or more, i.e., the piezoelectric speaker may be disposed inside the case 300 to improve the sound characteristics in the audible frequency band including the low pitch sound band and the high pitch sound band. That is, the sound output apparatus in accordance with the exemplary embodiment has the almost same sound characteristics as the dynamic speaker in a frequency ranging up to approximately 1.5 kHz and has the sound characteristics superior to the piezoelectric speaker in a frequency of approximately 1.5 kHz or more.

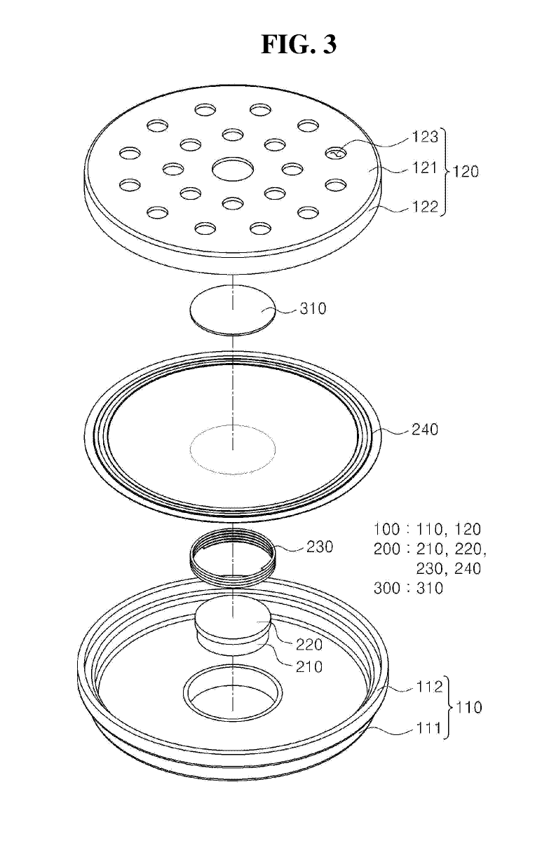

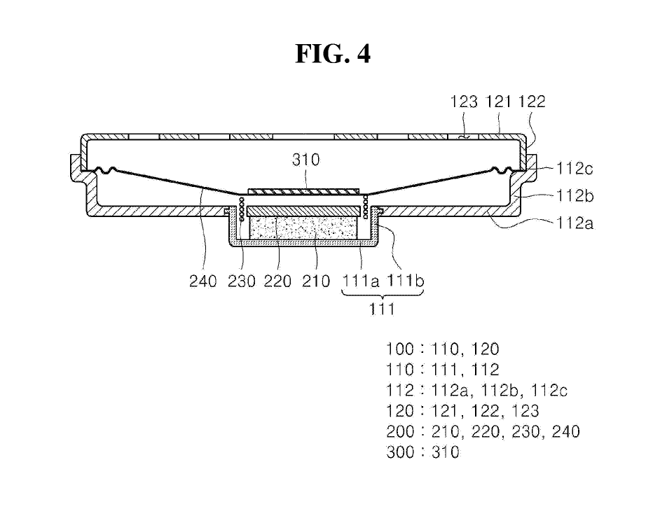

FIG. 3 is an exploded perspective view of a sound output apparatus in accordance with another exemplary embodiment, and FIG. 4 is a combined cross-sectional view of the sound output apparatus.

Referring to FIGS. 3 to 4, the sound output apparatus in accordance with another exemplary embodiment may include a case 100 in which a predetermined space is provided, a first sound output part 200 provided within the case 100, and a second sound output part 300 provided in the case 100 above the first sound output part 200. Here, the case 100 may include a lower case 110 and an upper case 120, and the first sound output part 200 may include a dynamic speaker including a magnet 210, a plate 220, a voice coil 230, and a vibrating member 240. Also, the second sound output part 300 may include a piezoelectric speaker including a piezoelectric plate 310 provided on the vibrating member 240. In another exemplary embodiment, an opening is not defined in the vibrating member 240 of the first sound output part 200. The vibrating member 240 may be divided into a first area and a second area. That is, the first area may have an approximately circular plate shape and be defined in the central portion of the vibrating member 240, which is spaced a predetermined distance from the plate 220 to face the plate 220, and the second area is defined to extend upward from an edge of the first area. Here, in another exemplary embodiment, the piezoelectric plate 310 may be disposed on a predetermined area of the vibrating member 240, for example, in the first area of the central portion thereof. Thus, the piezoelectric plate 310 and one area of the vibrating member 240 contacting the piezoelectric plate 310, i.e., a first area may function as a diaphragm to serve as the second output part 300. Also, the second area with which the piezoelectric plate 310 does not come into contact may be used as a diaphragm of the first sound output part 200. That is, the vibrating member 240 may be used as the first sound output part 200 and the second sound output part 300 at the same time.

In the sound output apparatus in accordance with the exemplary embodiments, the piezoelectric speaker is provided on the vibrating member of the dynamic speaker. Therefore, the exemplary embodiment may improve the sound characteristics in the audible frequency band by combining the dynamic speaker that has superior characteristics in the low pitch sound and the piezoelectric speaker that has superior characteristics in the high pitch sound into the single unit. Also, the sound output apparatus in accordance with the embodiments may be realized as the speaker and the earphone.

As described above, the technical idea of the present invention has been specifically described with respect to the above embodiments, but it should be noted that the foregoing embodiments are provided only for illustration while not limiting the present invention. Also, it will be understood by those skilled in the art that various embodiments can be made within the scope of the technical idea of the present invention.

1. An sound output apparatus, comprising:
a first sound output part;
a second sound output part disposed to contact at least a portion of the first sound output part; and
a case configured to accommodate the first and second sound output parts.

2. The sound output apparatus of claim 1, wherein the first sound output part comprises a voice coil and a vibrating member, and the second sound output part comprises a piezoelectric plate.

3. The sound output apparatus of claim 2, wherein an opening is defined in one area of the vibrating member, and a diaphragm and the piezoelectric plate are provided on the opening.

4. The sound output apparatus of claim 2, wherein the piezoelectric plate is disposed on one area of the vibrating member.

5. The sound output apparatus of claim 2, wherein the case comprises lower and upper cases, and an edge of the vibrating member is held between the lower and upper cases.

6. The sound output apparatus of claim 5, wherein the second sound output part is disposed at a side of the upper case.

7. The sound output apparatus of claim 6, further comprising a hole defined in the upper case to emit sounds generated from the first and second sound output parts.

8. The sound output apparatus of claim 1, wherein the case is provided with a size that is enough to be inserted into an ear of a user and inserted into the ear from the second sound output part.
